(19) United States
(12) Patent Application Publication
(10) Pub. No.: US 2017/0291454 A1
(43) Pub. Date: Oct. 12, 2017

(54) ELASTOMER LAMINATE COMPRISING THREE LAYERS

(71) Applicants: COMPAGNIE GENERALE DES ETABLISSEMENTS MICHELIN, Clermont-Ferrand (FR); MICHELIN RECHERCHE ET TECHNIQUE, S.A., Granges-Paccot (CH)

(72) Inventors: José-Carlos ARAUJO DA SILVA, Clermont-Ferrand Cedex 9 (FR); Baptiste FOGLIENI, Clermont-Ferrand Cedex 9 (FR)

(21) Appl. No.: 15/532,064

(22) PCT Filed: Nov. 23, 2015
(86) PCT No.: PCT/EP2015/077349

§ 371 Date: May 31, 2017

(30) Foreign Application Priority Data
Dec. 2, 2014 (FR) 1461754

(51) Int. Cl. B60C 11/00; B32B 25/16; B32B 25/14; B60C 1/00; B32B 7/12

(52) U.S. Cl. CPC B60C 11/0041; B60C 1/0016; B32B 7/12; B32B 25/14; B32B 25/16; B32B 2250/248; B32B 2264/108; B32B 2270/00; B32B 2274/00; B32B 2605/08

(57) ABSTRACT

An elastomer laminate comprising three layers is provided. The first layer consists of a diene rubber composition comprising a first elastomer matrix. The second layer consists of a diene rubber composition comprising a second elastomer matrix, which second elastomer matrix comprises a second terpolymeric elastomer of ethylene, of an α-olefin and of a non-conjugated diene and contains more than 10% by weight of diene units. The third layer consists of a diene rubber composition comprising a third diene elastomer having a content by weight of diene units of greater than 50%. The second layer is arranged between the first layer and the third layer. Such a laminate has good resistance to separation of the layers which constitute it.

This application is a 371 national phase entry of PCT/EP2015/077349, filed 23 Nov. 2015, which claims benefit of French Patent Application No. 1461754, filed 2 Dec. 2014, the entire contents of which are incorporated herein by reference for all purposes.

### BACKGROUND

### 1. Technical Field

The present invention relates to elastomer laminates comprising 3 layers of diene rubber composition, intended in particular to be used in a tire.

### 2. Related Art

A tire usually comprises a tread, two sidewalls, two beads, a carcass reinforcement passing into the two sidewalls and anchored to the two beads, and a crown reinforcement arranged circumferentially between the tread and the carcass reinforcement. The tread is intended to come into contact with the surface on which the tire runs. The tire may also comprise a tread underlayer, the underlayer being arranged circumferentially between the tread and the carcass reinforcement, preferably between the tread and the crown reinforcement, the tread underlayer generally being adjacent to the tread.

In the tire, the tread underlayer must adhere to the tread sufficiently in order to avoid the underlayer at the surface of the tread from detaching from the tread for the entire life of the tire. The underlayer generally adheres to the tread by means of physical or chemical phenomena, such as phenomena of interpenetration, entanglement or crosslinking of the diene rubber compositions constituting the tread and the tread underlayer, respectively. Under the conditions suitable for processing and curing diene rubber compositions placed against one another, these compositions are solidly bonded together and the complex obtained makes it possible to withstand the stresses associated with the field of application in question, especially that of tires.

The compositions which may be used in a tread may contain an elastomer matrix which has a low degree of unsaturation or which comprises a terpolymeric elastomer of ethylene, of an α-olefin and of a non-conjugated diene. An elastomer matrix is considered to have a low degree of unsaturation when it contains less than 10% by weight of diene units. Generally, the rubber composition of a tread underlayer is generally based on an elastomer matrix which comprises natural rubber, considered to be a highly unsaturated elastomer. However, the level of adhesion between, on the one hand, a first composition based on an elastomer matrix which has a low degree of unsaturation or which contains a terpolymeric elastomer of ethylene, of an α-olefin and of a non-conjugated diene, and on the other hand a second composition based on an elastomer matrix containing a highly unsaturated elastomer, may be deemed to be insufficient, especially for an application, in tires, of the first composition as tire tread and of the second composition as tread underlayer.

To overcome this, it is possible to use a material which will serve as bonding rubber or adhesive for bonding between the first composition and the second composition, especially used, respectively, as tire tread and tread underlayer. In this case, the tread underlayer is no longer adjacent over its entire length to the tread, but is separated therefrom by the bonding rubber.

### SUMMARY

The Applicants have solved the problem by using a diene rubber composition which serves as bonding rubber between these two compositions. Used as intermediate layer between the two compositions which each constitute a layer in a laminate, it makes it possible to significantly improve the resistance of the laminate to separation of the layers which constitute it.

Thus, a first subject of the invention is an elastomer laminate comprising 3 layers,
the first layer consisting of a diene rubber composition comprising a first elastomer matrix,
the second layer consisting of a diene rubber composition comprising a second elastomer matrix, which second elastomer matrix comprises a second terpolymeric elastomer of ethylene, of an α-olefin and of a non-conjugated diene and contains more than 10% by weight of diene units,
the third layer consisting of a diene rubber composition comprising a third diene elastomer having a content by weight of diene units of greater than 50%,
the second layer being arranged between the first layer and the third layer.

Another subject of the invention is the use of the laminate in accordance with the invention in a tire.

The invention also relates to a tire which comprises the laminate in accordance with the invention.

The invention also relates to the use of an adhesive composition identical to the diene rubber composition constituting the second layer of the laminate in accordance with the invention, to adhere a diene rubber composition identical to that constituting the first layer of the laminate in accordance with the invention to a diene rubber composition identical to that constituting the third layer of the laminate in accordance with the invention.

### I. DETAILED DESCRIPTION OF EXAMPLE EMBODIMENTS

The expression composition “based on” should be understood as meaning a composition comprising the mixture and/or the reaction product of the various constituents used, some of these base constituents being capable of reacting, or intended to react, with one another, at least in part, during the various phases of manufacture of the composition, in particular during the crosslinking or vulcanization thereof.

The expression “part by weight per hundred parts by weight of elastomer” (or phr) should be understood as meaning, within the context of the present invention, the portion by weight per hundred parts of elastomer present in the rubber composition in question and constituting a layer.

In the present description, unless expressly indicated otherwise, all the percentages (%) shown are percentages (%) by weight. Furthermore, any range of values denoted by the expression “between a and b” represents the range of values extending from more than a to less than b (that is to say, limits a and b excluded), whereas any range of values denoted by the expression “from a to b” means the range of values extending from a up to b (that is to say, including the strict limits a and b).

“Laminate” is intended to mean a product made of several layers, of planar or non-planar shape, in accordance with the definition given by the International Patent Classification.

The elastomer laminate in accordance with the invention comprises 3 layers,
the first layer consisting of a diene rubber composition comprising a first elastomer matrix,
the second layer consisting of a diene rubber composition comprising a second elastomer matrix, which second elastomer matrix comprises a second terpolymeric elastomer of ethylene, of an α-olefin and of a non-conjugated diene and contains more than 10% by weight of diene units,
the third layer consisting of a diene rubber composition comprising a third diene elastomer having a content by weight of diene units of greater than 50%,
the second layer being arranged between the first layer and the third layer.

The laminate in accordance with the invention is said to be elastomeric since it comprises 3 layers consisting of diene rubber compositions.

The laminate preferably consists of 3 layer defined according to any one of the embodiments of the invention.

By virtue of the nature of the elastomers which compose it, the diene rubber composition which constitutes the second layer is different from the diene rubber composition of the first layer and is different from the diene rubber composition of the third layer.

A “diene” elastomer (or “rubber”, the two terms being considered to be synonymous) should be understood, in a known way, to mean an (one or more is understood) elastomer resulting at least in part (i.e., a homopolymer or a copolymer) from diene monomers (monomers bearing two carbon-carbon double bonds which may or may not be conjugated).

A highly unsaturated diene elastomer is an elastomer having a content by weight of diene units of greater than 50%.

A diene elastomer which has a low degree of unsaturation is an elastomer having a content by weight of diene units of less than 10%.

The content of diene units related to an elastomer is expressed as percentage by weight per 100 g of the elastomer. It is therefore a content by weight. For example, a content by weight of diene units of x % in an elastomer A means that the diene units represent x g in 100 g of elastomer A, x being a number from 0 to 100, for example equal to 5. This formulation is equivalent to saying that elastomer A contains x % of diene units, or that elastomer A exhibits x % of diene units, or else that elastomer A has x % of diene units.

A diene unit is a monomer unit originating from the insertion of a monomer subunit resulting from the polymerization of a conjugated diene monomer or of a non-conjugated diene monomer, the diene unit comprising a carbon-carbon double bond.

An elastomer matrix of a rubber composition is all the elastomers contained in the rubber composition.

A highly unsaturated elastomer matrix is an elastomer matrix having a content by weight of diene units of greater than 50%. A highly unsaturated elastomer matrix typically contains one (or several) highly unsaturated diene elastomers having a content by weight of diene units of greater than 50%. By way of example, mention may be made of the homopolymeric elastomers and copolymers of 1,3-diene, especially butadiene or isoprene.

An elastomer matrix which has a low degree of unsaturation is an elastomer matrix having a content by weight of diene units of less than 10%. An elastomer matrix which has a low degree of unsaturation typically contains one (or several) diene elastomers which have a low degree of unsaturation having a content by weight of diene units of less than 10%. The elastomer matrix which has a low degree of unsaturation may nonetheless contain a highly unsaturated diene elastomer in a proportion such that the content by weight of diene units present in the elastomer matrix is less than 10%.

The content of diene units related to an elastomer matrix is expressed as percentage by weight per 100 g of the elastomer matrix. It is therefore a content by weight. For example, a content by weight of diene units of y % in an elastomer matrix B means that all the diene units present in elastomer matrix B represent y g in 100 g of elastomer matrix B, y being a number from 0 to 100, for example equal to 10. This formulation is equivalent to saying that elastomer matrix B contains y % of diene units, or that elastomer matrix B has y % of diene units.

Second Elastomer Matrix:

The second elastomer matrix has the essential feature of having more than 10% by weight of diene units and of comprising a terpolymer of ethylene, of an α-olefin and of a non-conjugated diene, referred to as second elastomer.

It is understood that the second elastomer may be a mix of terpolymers of ethylene, of α-olefin and of non-conjugated diene which differ from one another in terms of their macrostructure or their microstructure, in particular in terms of the respective amounts by weight of the ethylene, α-olefin and non-conjugated diene units.

According to a particular embodiment of the invention, the second elastomer has at least one, preferably all, of the following features:
the ethylene units represent between 20 and 90%, preferentially between 30 and 70% by weight of the second elastomer,
the α-olefin units represent between 10 and 80%, preferentially from 15 to 70% by weight of the second elastomer,
the non-conjugated diene units represent more than 10% by weight of the second elastomer.

According to a particular embodiment of the invention, the second elastomer contains more than 10% by weight of diene units, preferentially between 10 and 40%, more preferentially between 10 and 20% by weight of diene units. When the second elastomer has such a content of diene units, it is distinguished from terpolymers of ethylene, of α-olefin and of non-conjugated diene which are conventionally used in rubber compositions for tires, especially in tire sidewalls for their resistance to ageing and ozone, and which generally have a content of diene units of at most 10%.

In addition to the second elastomer, the second elastomer matrix may comprise another diene elastomer, in particular a highly unsaturated diene elastomer. Mention may be made, as highly unsaturated elastomer, of those containing conjugated diene monomer units, in particular 1,3-diene having 4 to 12 carbon atoms. The homopolymers and copolymers of butadiene and of isoprene are more particularly suitable. Advantageously, this other diene elastomer is a polyisoprene, preferably a polyisoprene with a high cis content, having a degree of 1,4-cis bonding of greater than 90%, which percentage is calculated on the basis of the weight of the polyisoprene, more preferentially natural rubber.

When the second elastomer matrix comprises this other highly unsaturated diene elastomer, the weight fraction of this other diene elastomer in the second diene elastomer matrix varies preferentially from 10 to 70% (of the weight of the second elastomer matrix).

According to a particular embodiment of the invention, the second elastomer matrix consists of the second elastomer and this other highly unsaturated diene elastomer.

According to another embodiment of the invention, the second elastomer represents more than 50% by weight of the second elastomer matrix, preferably more than 90% by weight of the second elastomer matrix, better still the entirety of the second elastomer matrix.

First Elastomer Matrix:

According to one embodiment of the invention, the first elastomer matrix comprises a terpolymer of ethylene, of an α-olefin and of a non-conjugated diene, hereinafter denoted the first elastomer or else referred to as the first terpolymeric elastomer of ethylene, of an α-olefin and of a non-conjugated diene.

According to a particular embodiment of the invention, the first elastomer has at least one and preferably all, of the following characteristics:
the ethylene units represent between 20 and 90%, preferentially between 30 and 70%, by weight of the second elastomer,
the α-olefin units represent between 10 and 80%, preferentially from 15 to 70%, by weight of the second elastomer,
the non-conjugated diene units represent between 0.5 and 10% by weight of the first elastomer.

According to a preferential embodiment of the invention, the first elastomer has a content by weight of diene units which is less than the content by weight of diene units of the second elastomer.

According to a more preferential embodiment of the invention, the first elastomer has a content by weight of diene units of less than 10%.

According to one embodiment of the invention, the first elastomer represents more than 50% by weight of the first elastomer matrix, preferably all of the first elastomer matrix.

According to another embodiment of the invention, the first elastomer matrix has a content by weight of diene units which is less than the content by weight of diene units of the second elastomer. For example, according to this embodiment of the invention, if the content by weight of diene units of the second elastomer is 14%, the content by weight of diene units of the first elastomer matrix is less than 14%, for example is of the order of 5%.

According to a particular embodiment of the invention, the first elastomer matrix has a content by weight of diene units which is less than the content by weight of diene units of the second elastomer and comprises the first terpolymeric elastomer of ethylene, of an α-olefin and of a non-conjugated diene.

According to another embodiment of the invention, the first elastomer matrix has less than 10% by weight of diene units and preferably comprises the first terpolymeric elastomer of ethylene, of an α-olefin and of a non-conjugated diene. The elastomer matrix is considered to be a matrix which has a low degree of unsaturation.

It is understood that the first elastomer may be a mixture of terpolymers of ethylene, of α-olefin and of non-conjugated diene which differ from one another in their macrostructure or their microstructure, in particular in the respective contents by weight of the ethylene, α-olefin and non-conjugated diene units.

The α-olefin, the monomer units of which constitute the first elastomer or the second elastomer, may be a mixture of α-olefins. The α-olefin generally comprises from 3 to 16 carbon atoms. Suitable as α-olefin are, for example, propylene, 1-butene, 1-pentene, 1-hexene, 1-octene and 1-dodecene. Advantageously, the α-olefin is propylene, in which case the terpolymer is commonly referred to as an EPDM rubber.

The non-conjugated diene, the monomer units of which constitute the first elastomer or the second elastomer, generally comprises from 6 to 12 carbon atoms. Mention may be made, as non-conjugated diene, of dicyclopentadiene, 1,4-hexadiene, 5-ethylidene-2-norbornene, 5-methylene-2-norbornene or 1,5-cyclooctadiene. Advantageously, the non-conjugated diene is 5-ethylidene-2-norbornene.

The first elastomer or the second elastomer is preferably a terpolymer of ethylene, of propylene and of 5-ethylidene-2-norbornene.

More preferentially, the first elastomer and the second elastomer are each a terpolymer of ethylene, of propylene and of 5-ethylidene-2-norbornene.

Third Diene Elastomer:

The third diene elastomer has the essential feature of having a content by weight of diene units of greater than 50%. The third diene elastomer may be an elastomer containing conjugated diene monomer units, in particular 1,3-diene containing 4 to 12 carbon atoms, advantageously isoprene.

It is understood that the third diene elastomer may be a mixture of elastomers which differ from one another in their macrostructure or their microstructure.

According to a preferential embodiment of the invention, the third diene elastomer is a polyisoprene. The polyisoprene as third diene elastomer is preferably a polyisoprene having a degree of 1,4-cis bonding of greater than 90%, which percentage is calculated on the basis of the weight of the polyisoprene. Advantageously, the third diene elastomer is natural rubber.

According to one embodiment of the invention, the third diene elastomer, advantageously polyisoprene or very advantageously natural rubber, represents at least 95% by weight, preferably all, of the elastomer matrix which constitutes the diene rubber composition of the third layer.

The microstructure of the elastomers is determined by ¹H NMR analysis, supplemented by ¹³C NMR analysis when the resolution of the ¹H NMR spectra does not enable the attribution and quantification of all the species. The measurements are carried out using a Bruker 500 MHz NMR spectrometer at frequencies of 500.43 MHz for observing protons and 125.83 MHz for observing carbons.

For the measurements of mixtures or elastomers which are insoluble but which have the ability to swell in a solvent, an HRMAS z-grad 4 mm probe is used, making it possible to observe protons and carbons in proton-decoupled mode. The spectra are acquired at spin speeds of 4000 Hz to 5000 Hz.

For the measurements of soluble elastomers, a liquid NMR probe is used, making it possible to observe protons and carbons in proton-decoupled mode.

The insoluble samples are prepared in rotors filled with the analyte and a deuterated solvent enabling swelling, in general deuterated chloroform (CDCl₃). The solvent used must always be deuterated and its chemical nature may be adapted by those skilled in the art. The amounts of analyte used are adjusted so as to obtained spectra with sufficient sensitivity and resolution.

The soluble samples are dissolved in a deuterated solvent (approximately 25 mg of elastomer in 1 ml), in general deuterated chloroform (CDCl₃). The solvent or solvent blend used must always be deuterated and its chemical nature may be adapted by those skilled in the art.

In both cases (soluble sample or swollen sample):

For the proton NMR, a simple 30° pulse sequence is used. The spectral window is adjusted to observe all the resonance lines belonging to the molecules analysed. The accumulation number is adjusted in order to obtain a signal to noise ratio that is sufficient for the quantification of each subunit. The recycle period between each pulse is adapted to obtain a quantitative measurement.

For the carbon NMR, a simple 30° pulse sequence is used with proton decoupling only during acquisition to avoid the “nuclear Overhauser” effects (NOE) and to remain quantitative. The spectral window is adjusted to observe all the resonance lines belonging to the molecules analysed. The accumulation number is adjusted in order to obtain a signal to noise ratio that is sufficient for the quantification of each subunit. The recycle period between each pulse is adapted to obtain a quantitative measurement.

The measurements are carried out at 25° C.

Reinforcing Filler:

The diene rubber composition which constitutes any one of the 3 layers preferably comprises a reinforcing filler, in particular when the laminate is used in a tire.

The reinforcing filler may be any type of “reinforcing” filler known for its abilities to reinforce a diene rubber composition which may be used for the manufacture of tires, for example an organic filler, such as carbon black, a reinforcing inorganic filler, such as silica, with which is combined, in a known way, a coupling agent, or else a mixture of these two types of fillers.

Such a reinforcing filler typically consists of nanoparticles, the (weight-)average size of which is less than a micrometre, generally less than 500 nm, usually between 20 and 200 nm, in particular and more preferentially between 20 and 150 nm.

All carbon blacks, especially the blacks conventionally used in tires or their treads (“tire-grade” blacks), are suitable as carbon blacks. Among the latter, mention will more particularly be made of the reinforcing carbon blacks of the series 100, 200, 300, or the blacks of the series 500, 600 or 700 (ASTM grades), such as for example the blacks N115, N134, N234, N326, N330, N339, N347, N375, N550, N683, N772. These carbon blacks can be used in the isolated state, as commercially available, or in any other form, for example as support for some of the rubber additives used.

“Reinforcing inorganic filler” should be understood here as meaning any inorganic or mineral filler, irrespective of its colour and its origin (natural or synthetic), also known as “white” filler, “clear” filler or even “non-black” filler, in contrast to carbon black, capable of reinforcing, by itself alone, without means other than an intermediate coupling agent, a diene rubber composition intended for the manufacture of pneumatic tires, in other words capable of replacing, in its reinforcing role, a conventional tire-grade carbon black; such a filler is generally characterized, in a known way, by the presence of hydroxyl (—OH) groups at its surface.

Mineral fillers of the siliceous type, preferentially silica (SiO₂), are suitable in particular as reinforcing inorganic fillers. The silica used can be any reinforcing silica known to those skilled in the art, especially any precipitated or fumed silica having a BET surface area and a CTAB specific surface area both of less than 450 m²/g, preferably from 30 to 400 m²/g, especially between 60 and 300 m²/g. As highly dispersible precipitated silicas (“HDSs”), mention will be made, for example, of the Ultrasil 7000 and Ultrasil 7005 silicas from Degussa, the Zeosil 1165MP, 1135MP and 1115MP silicas from Rhodia, the Hi-Sil EZ150G silica from PPG, the Zeopol 8715, 8745 and 8755 silicas from Huber and the silicas having a high specific surface area as described in application WO 03/016387.

In the present account, the BET specific surface area is determined in a known way by gas adsorption using the Brunauer-Emmett-Teller method described in The Journal of the American Chemical Society, Vol. 60, page 309, February 1938, more specifically according to French Standard NF ISO 9277 of December 1996 (multipoint (5 point) volumetric method—gas: nitrogen—degassing: 1 hour at 160° C.—relative pressure p/po range: 0.05 to 0.17). The CTAB specific surface area is the external surface area determined according to French Standard NF T 45-007 of November 1987 (method B).

The physical state in which the reinforcing inorganic filler is provided is unimportant, whether it is in the form of a powder, microbeads, granules or else beads. Of course, reinforcing inorganic filler is also understood to mean mixtures of various reinforcing inorganic fillers, in particular of highly dispersible silicas as described above.

Those skilled in the art will understand that use might be made, as filler equivalent to the reinforcing inorganic filler described in the present paragraph, of a reinforcing filler of another nature, especially organic, such as carbon black, provided that this reinforcing filler is covered with an inorganic layer, such as silica, or else comprises, at its surface, functional sites, especially hydroxyl sites, requiring the use of a coupling agent in order to establish the bond between the filler and the elastomer. Mention may be made, by way of example, of, for example, carbon blacks for tires, such as described, for example, in patent documents WO 96/37547 and WO 99/28380.

In order to couple the reinforcing inorganic filler to the diene elastomer, use is made, in a well-known way, of an at least bifunctional coupling agent, especially a silane, (or bonding agent) intended to provide a satisfactory connection, of chemical and/or physical nature, between the inorganic filler (surface of its particles) and the diene elastomer. Use is made in particular of at least bifunctional organosilanes or polyorganosiloxanes.

Use is especially made of silane polysulphides, referred to as “symmetrical” or “asymmetrical” depending on their specific structure, such as described, for example, in Applications WO 03/002648 (or US 2005/016651) and WO 03/002649 (or US 2005/016650).

Particularly suitable, without the definition below being limiting, are silane polysulphides corresponding to the general formula (V):

Z-A-Sₓ-A-Z (V)
in which:
x is an integer from 2 to 8 (preferably from 2 to 5);
the A symbols, which are identical or different, represent a divalent hydrocarbon radical (preferably a C₁-C₁₈ alkylene group or a C₆-C₁₂ arylene group, more particularly a C₁-C₁₀, especially C₁-C₄, alkylene, in particular propylene); a C₁-C₁₀
the Z symbols, which are identical or different, correspond to one of the three formulae below:

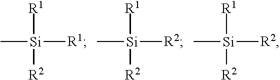

in which:
the R¹ radicals, which are substituted or unsubstituted and identical to or different from one another, represent a C₁-C₁₈ alkyl, C₅-C₁₈ cycloalkyl or C₆-C₁₈ aryl group (preferably C₁-C₆ alkyl, cyclohexyl or phenyl groups, especially C₁-C₄ alkyl groups, more particularly methyl and/or ethyl);
the R² radicals, which are substituted or unsubstituted and identical to or different from one another, represent a C₁-C₁₈ alkoxyl or C₅-C₁₈ cycloalkoxyl group (preferably a group chosen from C₁-C₈ alkoxyls and C₅-C₈ cycloalkoxyls, even more preferentially a group chosen from C₁-C₄ alkoxyls, in particular methoxyl and ethoxyl).

In the case of a mixture of alkoxysilane polysulphides corresponding to the above formula (I), especially customary commercially available mixtures, the mean value of “x” is a fractional number preferably of between 2 and 5, more preferentially close to 4. However, the invention can also advantageously be carried out, for example, with alkoxysilane disulphides (x=2).

Mention will more particularly be made, as examples of silane polysulphides, of bis((C₁-C₄)alkoxyl(C₁-C₄)alkylsilyl(C₁-C₄)alkyl) polysulphides (in particular disulphides, trisulphides or tetrasulphides), such as, for example, bis(3-trimethoxysilylpropyl) or bis(3-triethoxysilylpropyl) polysulphides. Use is made in particular, among these compounds, of bis(3-triethoxysilylpropyl) tetrasulphide, abbreviated to TESPT, of formula [(C₂H₅O)₃Si(CH₂)₃S₂]₂, or bis(triethoxysilylpropyl) disulphide, abbreviated to TESPD, of formula [(C₂H₅O)₃Si(CH₂)₃S]₂.

As coupling agent other than alkoxysilane polysulphide, mention will especially be made of bifunctional POSs (polyorganosiloxanes), or else of hydroxysilane polysulphides, such as described in patent applications WO 02/30939 (or U.S. Pat. No. 6,774,255) and WO 02/31041 (or US 2004/051210), or else of silanes or POSs bearing azodicarbonyl functional groups, such as described, for example, in patent applications WO 2006/125532, WO 2006/125533 and WO 2006/125534.

As coupling agent, mention may also be made of alkoxysilanes bearing an unsaturated carbon-based group capable of reacting, by the radical route, with a diene unit of the elastomer matrix. By way of example, mention may be made of 3-butene-triethoxysilane or 3-methacryloxypropyltrimethoxysilane.

The content of coupling agent is advantageously less than 20 phr (parts by weight per hundred parts of elastomer present in the rubber composition in question constituting one layer), it being understood that it is generally desirable to use as little as possible thereof. Typically, the content of coupling agent represents from 0.5% to 15% by weight relative to the amount of inorganic filler. Its content is preferentially between 0.5 and 12 phr, more preferentially within a range extending from 3 to 10 phr. This content is easily adjusted by those skilled in the art depending on the content of inorganic filler used in the diene rubber composition.

According to a particular embodiment of the invention, each of the diene rubber compositions constituting respectively the 3 layers of the laminate comprises a reinforcing filler, preferably a carbon black.

Content of Reinforcing Filler:

The content of reinforcing filler in each of the diene rubber compositions of the laminate may vary to a great extent, for example depending on the nature of the elastomer matrix or of the reinforcing filler in the diene rubber composition or depending on the amount of plasticizing agent in the diene rubber composition. These variables are adjusted by those skilled in the art as a function of the use made of the laminate, especially in a tire.

In the case of using a laminate in which the first layer of the laminate constitutes a tread intended to be fitted on a tire and the third layer constitutes a tread underlayer, the nature of the reinforcing filler in the diene rubber composition of the first layer and of the third layer, and also the content thereof, are chosen by those skilled in the art to be suitable for the particular conditions of this use. For example, the reinforcing filler may be a carbon black, a silica or a mixture thereof, the content thereof in the diene rubber composition being able to vary from 20 to 200 phr.

According to any one of the embodiments of the invention, the content of reinforcing filler in the diene rubber composition of the second layer preferably varies from 5 to 80 phr, more preferentially from 5 to 50 phr.

According to a particular embodiment of the invention, the diene rubber composition of the second layer comprises a content of reinforcing filler which is less than or equal to the content of reinforcing filler of the diene rubber composition of the first layer.

Other Additives:

The diene rubber composition constituting any one of the 3 layers may also contain, in addition to the coupling agents, coupling activators, agents for covering the inorganic fillers or more generally processing aids capable, in a known way, by virtue of an improvement in the dispersion of the filler in the rubber matrix and of a lowering of the viscosity of the diene rubber composition, of improving the ability thereof to be processed in the uncured state.

It may also comprise all or a portion of the usual additives customarily used in elastomer compositions intended to constitute mixtures of rubber finished articles such as tires, such as, for example, pigments, protective agents, such as antiozone waxes, chemical antiozonant, antioxidants, antifatigue agents, a crosslinking system, vulcanization accelerators or retardants, or vulcanization activators. When the elastomer matrix contains a terpolymer of ethylene, of α-olefin and of non-conjugated diene, in particular an EPDM, it is possible to use crosslinking coagents customarily used in the crosslinking of EPDMs. As crosslinking coagent, mention may be made of triallyl isocyanurate, ethylene dimethacrylate, or trimethylolpropane trimethacrylate. The crosslinking system is preferably based on sulphur but it may also be based on sulphur donors, on peroxide, on bismaleimide or on mixtures thereof.

The diene rubber compositions which constitute respectively the first layer, the second layer and the third layer preferably comprise a crosslinking system, preferably a vulcanization system.

The diene rubber compositions which may be used for the purposes of the invention may also comprise plasticizing agents, for example extending oils of aromatic or non-aromatic nature, especially very slightly aromatic or non-aromatic oils (e.g. paraffinic or hydrogenated naphthenic oils, or MES or TDAE oils), vegetable oils, in particular glycerol esters such as glycerol trioleates, hydrocarbon-based plasticizing resins having a high Tg, preferably of greater than 30° C., such as those described, for example, in applications. The content of plasticizing agent is adjusted by those skilled in the art as a function of the viscosity and of the properties sought for the diene rubber composition, which are determined by the use which will be made of the diene rubber composition. The viscosity of the diene rubber composition itself depends on numerous variables, such as the viscosity of the elastomer matrix, the content of reinforcing filler, the interactions which may exist between the elastomer matrix and its reinforcing filler. Thus, those skilled in the art, with their general knowledge, choose the suitable content of plasticizing agent while taking these different variables into account.

If the diene rubber composition of the second layer which may be used for the purposes of the invention contains a plasticizing agent, it preferably contains at most 20 phr, more preferentially less than 10 phr, even more preferentially less than 5 phr thereof. These preferential embodiments make it possible to achieve very noteworthy levels of adhesion between the first and the third layer, by virtue of the interphase consisting of the second layer.

According to another embodiment of the invention, the diene rubber composition of the second layer does not contain plasticizing agent. This embodiment which is advantageous from the point of view of adhesion performance is particularly suited to the diene rubber compositions constituting the second layer which have a low content of filler, especially those which comprise at most 50 phr of reinforcing filler.

Preparation of the Diene Rubber Compositions:

The diene rubber compositions which may be used for the purposes of the invention are manufactured in appropriate mixers, using two successive phases of preparation well known to those skilled in the art: a first phase of thermomechanical working or kneading (“non-productive” phase) at high temperature, up to a maximum temperature of between 130° C. and 200° C., followed by a second phase of mechanical working (“productive” phase) down to a lower temperature, typically below 110° C., for example between 40° C. and 100° C., finishing phase during which the crosslinking system is incorporated.

Preparation of the Iaminate:

In the manufacture of the laminate in accordance with the invention, the diene rubber compositions constituting the layers are affixed to one another in the uncured state. In order to facilitate interfacial adhesion, the layers are preferably applied under hot conditions, the layers being in the uncured state.

It will be readily understood that, depending on the specific fields of application, the laminate in accordance with the invention may comprise several preferential thickness ranges. Thus, for example, for pneumatic tires of passenger vehicle type, the first layer and third layer may have a thickness of at least 2 mm, preferentially of between 3 and 10 mm. According to another example, for pneumatic tires for heavy-goods or agricultural vehicles, the preferential thickness may be between 2 and 20 mm for the first and third layers. According to another example, for pneumatic tires for vehicles in the field of civil engineering or for aeroplanes, the preferential thickness of the first and third layers may be between 2 and 100 mm.

According to any one of the embodiments of the invention, the second layer preferably has a thickness ranging from 60 μm to a few millimetres, for example from 100 μm to 5 mm. The thickness is adjusted as a function of the particular conditions of use of the laminate.

For the smallest thicknesses, in particular of the order of a few hundred μm, the layers are preferably formed by applying the diene rubber composition in the form of a dissolution composed of a volume of solvent. For greater thicknesses, preference is given to calendering or even extruding the diene rubber composition in the form of a layer.

In order to manufacture the laminate, the layers may be arranged on top of one another by successive application of the layers, for example on a building drum conventionally used in the manufacture of pneumatic tires (or tire casings). For example, the first layer is placed on the drum, the second layer on the first layer, the third layer on the second layer.

The laminate may either be in the uncured state (before crosslinking or vulcanization) or in the cured state (after crosslinking or vulcanization).

In the manufacture of a tire containing the laminate, the laminate may be manufactured prior to the manufacture of the tire or during the manufacture of the tire. In the former case, the laminate formed beforehand and in the uncured state may be applied to the tire by placing it for example on the carcass reinforcement or the crown reinforcement of the tire, also in the uncured state. In the second case, the third layer may be placed for example on the carcass reinforcement or the crown reinforcement of the tire, also in the uncured state, then the second layer placed on the third layer and the first layer on the second layer, the first, second and third layers being in the uncured state.

The laminate may be used in a tire, the tire comprising a tread, two sidewalls, two beads, a carcass reinforcement passing into the two sidewalls and anchored to the two beads, and a crown reinforcement arranged circumferentially between the tread and the carcass reinforcement.

According to one embodiment of the invention, the laminate is used in a tire such that the first layer constitutes a portion or all of the tire tread and the third layer constitutes a portion or all of a tread underlayer.

According to a preferential embodiment of the invention in which the laminate is used in a tire, the first layer constitutes all of the tread and the third layer constitutes all of a tread underlayer.

When the third layer in the laminate is used as a tire tread underlayer, it is preferably not intended to come into contact with the surface on which the tire runs.

The tire, which is provided with the laminate and which represents another subject of the invention, may be in the cured or uncured state.

The abovementioned features of the present invention, and also others, will be better understood on reading the following description of several exemplary embodiments of the invention, given by way of nonlimiting illustration.

### II. EXEMPLARY EMBODIMENTS

II.1-Preparation of the Diene Rubber Compositions and Laminates:

The following procedure is used for the compositions, the formulation of which is shown in Table 1:

The elastomer, the reinforcing filler and also the various other ingredients, with the exception of the vulcanization system, are successively introduced into an internal mixer (final degree of filling: approximately 70% by volume), the initial vessel temperature of which is approximately 80° C. Thermomechanical working (non-productive phase) is then carried out in one step, which lasts in total approximately 3 to 4 min, until a maximum “dropping” temperature of 165° C. is reached. The mixture thus obtained is recovered and cooled and then sulphur and an accelerator of sulphenamide type are incorporated on a mixer (homofinisher) at 30° C., everything being mixed (productive phase) for an appropriate time (for example approximately ten minutes).

The compositions thus obtained are subsequently calendered in the form of slabs (thickness of 2 to 3 mm) or of layers for the measurement of their respective levels of adhesion.

Compositions C1, C2 and C3 differ by the nature of the elastomer matrix of which they are respectively composed.

Composition C1 represents the first layer of the laminate and contains an elastomer EPDM with a low degree of unsaturation, comprising 5% by weight of diene units.

Composition C2 represents the second layer of the laminate and contains an elastomer EPDM comprising 14% by weight diene units and therefore by definition not having a low degree of unsaturation.

Composition C3 represents the third layer of the laminate and contains a highly unsaturated elastomer E3, natural rubber.

II.2-Measurements and Tests Used:

Adhesion is measured by a T-type peel test, also referred to as 180° peeling. The peeling test specimens are produced by bringing the two layers (the compositions constituting the layers being in the uncured state) for which the adhesion is to be tested into contact. An incipient crack is inserted between the two layers. Each of the layers is reinforced by a composite ply which limits the deformation of said layers under traction.

The test specimen, once assembled, is brought to 150° C. under a pressure of 16 bar, for 30 minutes. Strips with a width of 30 mm are then cut out using a cutting machine. The two sides of the incipient crack were subsequently placed in the jaws of a tensile testing device with the Instron brand name. The tests are carried out at 20° C. and at a pull speed of 100 mm/min. The tensile stresses are recorded and the latter are standardized by the width of the test specimen. A curve of strength per unit width (in N/mm) as a function of the movable crosshead displacement of the tensile testing machine (between 0 and 200 mm) is obtained. The adhesion value selected corresponds to the propagation of the crack within the test specimen and thus to the mean stabilized value of the curve. The adhesion values of the examples are standardized relative to a control (base 100).

The adhesion is measured between the two layers C1 and C3, between the two layers C1 and C2, and between the two layers C2 and C3. The value of the measurement of adhesion between the two layers C1 and C3 is selected as the control value, since the laminate comprising just the two layers C1 and C3 is not in accordance with the invention due to the absence of the layer C2.

Table 2 presents the results obtained after peel tests at room temperature. The results are expressed as performance index. An index of greater than 100 indicates a greater improvement in adhesion.

It is observed that the performance indices of adhesion, on the one hand between the first layer and the second layer, and on the other hand between the second layer and the third layer, are the highest (600 and 265, respectively) relative to the control. The presence, in a laminate, of the second layer between the first layer and the third layer of the laminate makes it possible to very greatly increase the resistance of the laminate to the separation of the layers which constitute it, compared to the control laminate only comprising the layers C1 and C3.

TABLE 1

| | C1 | C2 | C3 |
|---|---|---|---|
| NR (1) | — | — | 100 |
| EPDM (2) | 100 | — | — |
| EPDM (3) | — | 100 | — |
| Carbon black (4) | 30 | 30 | 30 |
| Antioxidant (5) | 1.5 | 1.5 | 1.5 |
| Stearic acid (6) | 2.5 | 2.5 | 2.5 |
| Zinc oxide (7) | 3 | 3 | 3 |
| Accelerator (8) | 2.0 | 2.0 | 2.0 |
| Sulphur | 1.0 | 1.0 | 1.0 |

(1) Natural rubber
(2) EPDM, Nordel IP 4570 from Dow
(3) EPDM 9090M from Mitsui
(4) Carbon black of N234 grade according to Standard ASTM D-1765
(5) N-(1,3-Dimethylbutyl)-N-phenyl-para-phenylenediamine: Santoflex 6-PPD from Flexsys
(6) Stearin, Pristerene 4931 from Uniqema
(7) Zinc oxide of industrial grade from Umicore
(8) N-Cyclohexyl-2-benzothiazolesulphenamide, Santocure CBS from Flexsys

TABLE 2

| | Interface between | | |
|---|---|---|---|
| | layers tested | | |
| | C1/C3 | C2/C3 | C2/C1 |
| Level of adhesion | 100 | 265 | 600 |

1. An elastomer laminate comprising:
a first layer consisting of a diene rubber composition comprising a first elastomer matrix,
a second layer consisting of a diene rubber composition comprising a second elastomer matrix, which second elastomer matrix comprises a second terpolymeric elastomer of ethylene, of an α-olefin and of a non-conjugated diene and contains more than 10% by weight of diene units,
a third layer consisting of a diene rubber composition comprising a third diene elastomer having a content by weight of diene units of greater than 50%,
the second layer being arranged between the first layer and the third layer.

2. An elastomer laminate according claim 1, in which the first elastomer matrix comprises a first terpolymeric elastomer of ethylene, of an α-olefin and of a non-conjugated diene.

3. An elastomer laminate according to claim 2, in which the first elastomer is an EPDM.

4. An elastomer laminate according to claim 2, in which the first elastomer has a content by weight of diene units which is less than the content by weight of diene units of the second elastomer.

5. An elastomer laminate according to claim 2, in which the first elastomer has a content by weight of diene units of less than 10%.

6. An elastomer laminate according to claim 2, in which the first elastomer represents more than 50% by weight of the first elastomer matrix.

7. An elastomer laminate according to claim 1, in which the first elastomer matrix has a content by weight of diene units which is less than the content by weight of diene units of the second elastomer.

8. An elastomer laminate according to claim 1, in which the first elastomer matrix has less than 10% by weight of diene units.

9. An elastomer laminate according to claim 1, in which the second elastomer contains more than 10% by weight of diene units.

10. An elastomer laminate according to claim 1, in which the second elastomer is an EPDM.

11. An elastomer laminate according to claim 1, in which the second elastomer matrix comprises another highly unsaturated diene elastomer.

12. An elastomer laminate according to claim 11, in which the second elastomer matrix consists of the second elastomer and the other highly unsaturated diene elastomer.

13. An elastomer laminate according to claim 11, in which the other highly unsaturated diene elastomer is a polyisoprene.

14. An elastomer laminate according to claim 1, in which the second elastomer represents more than 50%, by weight of the second elastomer matrix.

15. An elastomer laminate according to claim 1, in which the second elastomer represents all of the second elastomer matrix.

16. An elastomer laminate according to claim 1, in which the third diene elastomer comprises monomeric 1,3-diene units.

17. An elastomer laminate according to claim 16, in which the third diene elastomer is a polyisoprene.

18. An elastomer laminate according to claim 1, in which the third diene elastomer represents at least 95% by weight.

19. An elastomer laminate according to claim 1, in which the diene rubber composition which constitutes any one of the 3 layers comprises a reinforcing filler.

20. An elastomer laminate according to claim 19, in which the diene rubber compositions which constitute respectively the first layer, the second layer and the third layer comprise a reinforcing filler.

21. An elastomer laminate according to claim 1, in which the diene rubber composition which constitutes any one of the 3 layers comprises a crosslinking system.

22. An elastomer laminate according to claim 21, in which the diene rubber compositions which constitute respectively the first layer, the second layer and the third layer comprise a crosslinking system.

23. An elastomer laminate according to claim 1, in which the diene rubber composition of the second layer contains at most 20 phr of plasticizing agent.

24. An elastomer laminate according to claim 1, in which the diene rubber composition of the second layer does not contain plasticizing agent.

25. A tire, of an elastomer laminate defined according to claim 1.

26. A tire comprising a tread, two sidewalls, two beads, a carcass reinforcement passing into the two sidewalls and anchored to the two beads, and a crown reinforcement arranged circumferentially between the tread and the carcass reinforcement, which tire comprises an elastomer laminate according to claim 1.

27. A tire according to claim 26, in which the first layer of the elastomer laminate constitutes a portion or all of the tire tread and the third layer of the elastomer laminate constitutes a portion or all of a tread underlayer.

28. An adhesive composition to adhere two compositions, wherein the adhesive composition comprises a second elastomer matrix, which second elastomer matrix comprises a second terpolymeric elastomer of ethylene, of an α-olefin and of a non-conjugated diene and contains more than 10% by weight of diene units, and the two compositions to be adhered are respectively identical to the diene rubber compositions constituting the first layer and the third layer defined according to claim 1.

29. An elastomer laminate according to claim 3, in which the first elastomer is a terpolymer of ethylene, of propylene and of 5-ethylidene-2-norbornene.

30. An elastomer laminate according to claim 9, in which the second elastomer contains between 10 and 40% by weight of diene units.

31. An elastomer laminate according to claim 10, in which the second elastomer is a terpolymer of ethylene, of propylene, and of 5-ethylidene-2-norbornene.

32. An elastomer laminate according to claim 11, in which the highly unsaturated diene elastomer represents from 10 to 70% by weight of the second elastomer matrix.

33. An elastomer laminate according to claim 13, in which the other highly unsaturated diene elastomer is a polyisoprene with a high cis content, having a degree of 1,4-cis bonding of greater than 90%.

34. An elastomer laminate according to claim 17, in which the third diene elastomer has a degree of cis-1,4-bonding of greater than 90.
